(19) United States
(12) Patent Application Publication
(10) Pub. No.: US 2015/0097135 A1
(43) Pub. Date: Apr. 9, 2015

(54) METHOD FOR GENERATING COLLOIDAL GAS APHRONS

(71) Applicant: SCHLUMBERGER TECHNOLOGY CORPORATION, SUGAR LAND, TX (US)

(72) Inventors: OLEG MIKHAILOVICH ZOZULYA, MOSCOW (RU); VERA ANATOLYEVNA PLETNEVA, SAROV (RU)

(21) Appl. No.: 14/496,347

(22) Filed: Sep. 25, 2014

(30) Foreign Application Priority Data
Oct. 7, 2013 (RU) 2013144667

(51) Int. Cl. B01J 13/00

(52) U.S. Cl. CPC B01J 13/00
USPC 252/3; 507/102; 507/202; 252/180; 252/61; 516/10

(57) ABSTRACT

A polymer solution is mechanically mixed with at least one surfactant solution under conditions preventing air access. The produced polymer-surfactant solution is saturated with a gas by increasing pressure to a value ensuring complete gas dissolution and exceeding an expected pressure of use of aphrons. Then, the pressure is rapidly reduced to a value corresponding to the expected pressure of use of the aphrons and narrow size distribution aphrons are produced.

### CROSS-REFERENCE TO RELATED APPLICATION

This application claims priority to Russian Application No. 2013144667 filed Oct. 7, 2013, which is incorporated herein by reference in its entirety.

### BACKGROUND

Colloidal gas aphrons are 10-100 micron gas bubbles with viscous shells formed by polymer molecules adsorbed from solution. The viscous shell is stabilized from a gas side and from a solution part by various surfactants. Their first description was made and the term “aphron” was introduced for the first time in the paper SEBBA, F., Foams and Biliquid Foams-Aphrons; John Wiley & Sons Inc., Toronto, ON, 1987.

This structure of aphrons distinguishes them from ordinary foams, in which air bubbles are stabilized by a monomolecular layer of surfactants. A dense viscous layer and a thick layer of a surfactant on the surface of aphron bubbles prevent their coagulation and decelerate gas diffusion into the solution. This makes the aphrons highly strong mechanically and stable (compared with foam bubbles).

These properties allow using gas aphrons as part of liquids for oil-and-gas well killing, in compositions of muds, etc. The main problem from the point of efficient application of gas aphrons in oil-field production consists in preparation of microbubble mixtures capable of sustaining reservoir pressures and temperatures. Indeed, the stability of such mixtures was thoroughly studied in medical ultrasonic diagnostics, where stabilized microbubbles are widely used as contrast agents injected intravenously to generate significantly higher contrast ultrasonic images and deliver medicines to affected organs. The ultrasonic contrast agents used in medicine consist of encapsulated microbubbles filled with heavy gases, usually perfluorohydrocarbons, shells of which are formed from lipids, proteins or surfactants (see, for example, Contrast Media in Ultrasonography. Basic Principles and Clinical Applications.—Ed: E. Quaia, Springer-Verlag Berlin, Heidelberg, 2005, p. 401).

Methods of generation and application of colloidal gas aphrons are described, for example, in the F. B. Growcock, A. Belkin, M. Fosdick, M. Irving, B. O'Connor, T. Brookey, Recent Advances in Aphron Drilling-Fluid Technology,—SPE 97982, 2007, p. 74-80. The aphrons described in this work withstand pressures up to 40 MPa and are widely used in drilling: they prevent mud losses and formation damage due to the effective wellbore sealing.

U.S. Pat. No. 5,881,826 also describes a method for generating gas aphrons and their application in a mud.

N. Bjorndalen, E. Kuru. Physico-chemical characterization of aphron-based drilling fluids,—J. Can. Petrol. Technol., 2008, vol. 47, No. 11, p. 15-21, describes a standard procedure for generating colloidal gas aphrons by mechanical dispersion of a polymer-surfactant solution as a result of which the solution is filled with free gas and transforms into colloidal gas aphrons with a wide bubble size distribution.

Known methods involve preparing colloidal gas aphrons in a viscous aqueous polymer solution under intensive stirring using a high-speed blade mixer. Decompression voids emerging in such turbulent rotational flow give rise to the formation of bubbles of various sizes resulting in a wide final size distribution of the produced aphrons. The wide size distribution is a disadvantage of this generation method, if a task is to generate aphrons with pressure controlled average size. Indeed, experiments show that the bubble collapsing pressure is proportional to the initial bubble size, i.e. only the initially large bubbles sustain high pressures. Thus, as the pressure rises, the bubble size distribution not only shifts to smaller sizes, but also gets curtailed on the low-size side.

### SUMMARY

The disclosure provides for generating stable monodisperse colloidal gas aphrons of controlled size.

For generating colloidal gas aphrons, mechanical homogenization of solutions of a polymer and of at least one surfactant is performed under conditions preventing air access. Then, the produced solution is saturated with a gas by increasing pressure to a value ensuring total gas dissolution and being over an expected aphron use pressure. The pressure is rapidly reduced to the value corresponding to the expected aphron use pressure.

Xanthane polymer can be used as the polymer, although other polymers may also be used, e.g., potassium alginate, guar or partially hydrolized polyacrylamide.

Sodium dodecyl sulfate and sodium stearate can be used as the surfactants. Other surfactants may also be used, for example, saporins or Blue Streak®.

The polymer and the surfactant solutions may be mixed in atmosphere of the gas.

### BRIEF DESCRIPTION OF DRAWINGS

The disclosure is illustrated with the drawings wherein:

FIG. 1 shows colloidal gas aphrons generated with a standard method; and

FIG. 2 shows colloidal gas aphrons generated in accordance with various embodiments of the present disclosure.

### DETAILED DESCRIPTION

The invention relates to methods of generating water-gas microbubble mixtures and might be applied in various oil production technologies such as drilling, well completion, monitoring, hydrofracturing, etc. The invention might be used in other fields as well, for example, in separation (treatment of metal or organic dye contaminated water, removal of algae from polluted water, remediation of hydrocarbon contaminated soil, protein separation, chamber flotation), fire-fighting, fermentation, material synthesizing and for bioreactors.

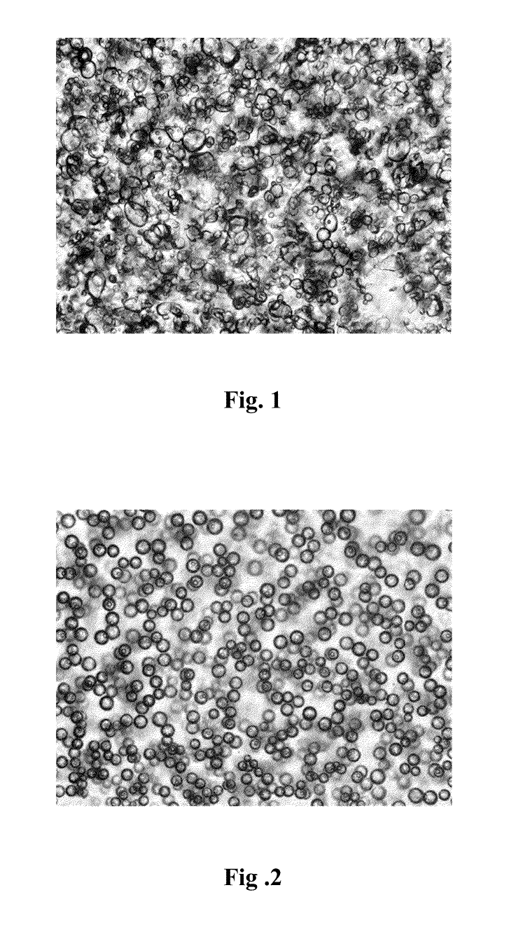

To produce a narrow bubble size distribution, a first surfactant solution is mixed with a polymer solution in a filled and sealed vessel (to prevent air access to the mixture). The produced polymer-surfactant solution is then saturated with some amount of a required gas at a saturation pressure of Pₛₐₜ. A separating reservoir with a moving piston is used for this, and besides the produced solution, the gas is injected into the reservoir at a pressure of Pᵣₑₛ. The separating reservoir is connected to a pump that creates excessive pressure on an opposite side of the moving piston and allows pressure in the system to rise to a value of Pₛₐₜ at which the gas dissolves totally. An initial volume of the gas at Pᵣₑₛ should be selected based on its solubility at Pₛₐₜ. A subsequent quick reduction of pressure to a given value of P<Pₛₐₜ (decompression) results in generation of gas phase nuclei (microbubbles) in the supersaturated solution. As known from theory and practice of generating monodisperse “wet” foams (K. Taki, Experimental and numerical studies on the effects of pressure release rate on number density of bubbles and bubble growth in a polymeric foaming process,—Chem. Eng. Sci. 2008, vol. 63, p. 3643-3653), an average size, a degree of monodispersion and a concentration of bubbles depend both on a degree of the solution supersaturation (Pₛₐₜ) and the pressure relief rate. Indeed, the higher the pressure relief rate, the shorter the period of time during which the gas phase nuclei are generated and, thus, the more monodisperse the aphron is. The microbubble mixtures produced in this way have narrow size distribution being and are ordinary aphrons, i.e. the bubbles have a typical multilayer shell capable of reforming, if the pressure changes, and preventing bubble coagulation. The aphrons generated by a standard method are shown in FIG. 1, and the aphrons generated by the suggested method are shown in FIG. 2 (pressure=1 MPa).

Below is an example of implementing the method of generating air aphrons intended for oil-field applications and for use at reservoir pressures (operating pressure=30-70 MPa). First, basic aqueous solutions of xanthane (concentration 15 g/l), sodium dodecyl sulfate (concentration 200 g/l) and sodium stearate (concentration 15 g/l) are prepared. Then, the heated sodium stearate solution (T=85° C.) (heating is required for dissolution of the stearic acid not dissolved in water at room temperature) is rapidly added to the xanthane-sodium dodecyl sulfate solution in required proportion (to get the concentration of, for example, 5 g/l in the final solution), which is produced by mixing basic solutions of xanthane and sodium dodecyl sulphate (to get their concentrations in the final solution, for example, of 10 g/l and 5 g/l respectively) in required proportions. The initial mixture concentration of xanthane: sodium stearate: sodium dodecyl sulphate is 2:1:1. Then, the mixture is intensively stirred for 10 minutes at 2,000 rpm. As a result sodium stearate is totally dissolved. Then, the prepared 200 ml solution is poured into a 1 liter separating reservoir. The rest of the reservoir space remains air filled (at atmospheric pressure). Then, rapidly increasing the pressure up to 40 MPa, ensure that the air contained in the reservoir dissolves totally. Then, reducing the pressure at the rate of 2 MPa/s to the required value (1 MPa for FIG. 2), the solution is transferred to supersaturated state resulting in generation of gas phase nuclei and producing narrow size distribution aphron.

1. A method for generating colloidal gas aphrons comprising:
mechanically mixing a polymer solution with at least one surfactant solution under conditions preventing air access;
saturating the obtained polymer-surfactant solution with a gas by increasing pressure to a value ensuring complete gas dissolution and exceeding an expected pressure of use of the aphrons, and
rapidly reducing the pressure to a value corresponding to the expected pressure of use of the aphrons.

2. The method of claim 1, wherein the pressure is reduced at a controlled rate.

3. The method of claim 1, wherein the polymer solution comprises xanthane polymer.

4. The method of claim 1, wherein the polymer solution comprises potassium alginate.

5. The method of claim 1, wherein the polymer solution comprises guar.

6. The method of claim 1, wherein the polymer solution comprises partially hydrolized polyacrylamide.

7. The method of claim 1, wherein the surfactant solution comprises sodium dodecyl sulphate and sodium stearate.

8. The method of claim 1, wherein the surfactant solution comprises saporins.

9. The method of claim 1, wherein the mechanically mixing the polymer and the surfactant solutions is carried out in an atmosphere comprising the gas.
